(19) United States
(12) Patent Application Publication
(10) Pub. No.: US 2005/0129319 A1
(43) Pub. Date: Jun. 16, 2005

(54) Fast discrete wavelet encoding apparatus and method for encoding a still image at a high speed based on energy of each block

(75) Inventors: Hyun-Seung Lee, Suwon-si (KR); Dae-won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/865,510

(22) Filed: Jun. 10, 2004

(30) Foreign Application Priority Data
Dec. 10, 2003 (KR) 2003-89715

(51) Int. Cl. G06K 9/36

(52) U.S. Cl. 382/239; 382/240

(57) ABSTRACT

A fast discrete wavelet encoding apparatus and method for encoding and decoding a still image are provided. In the fast discrete wavelet encoding apparatus, an energy calculator calculates the energy of an input image, block by block, each block having a predetermined number of pixels, an adaptive image decomposer determines a lifting transform level for each block adaptively according to the energy of the block, and a lifting encoder lifting encodes the input image according to the lifting transform levels determined for the blocks of the image.

### PRIORITY

This application claims priority under 35 U.S.C. § 119 to an application entitled “Fast Discrete Wavelet Encoding Apparatus and Method for Encoding Still Image at High Speed Based on Energy of Each Block” filed in the Korean Intellectual Property Office on Dec. 10, 2003 and assigned Serial No. 2003-89715, the contents of which are incorporated herein by reference.

### BACKGROUND OF THE INVENTION

1. Field of the Invention

The present invention relates generally to an apparatus and method for performing JPEG2000 (Joint Photographic Experts Group 2000)-based DWT (Discrete Wavelet Transform) and IDWT (Inverse Discrete Wavelet Transform), and in particular, to a JPEG2000-based DWT/IDWT apparatus and method for performing fast DWT/IDWT encoding/decoding based on the energy of each image block received in a time domain in a JPEG2000 CODEC.

2. Description of the Related Art

The existing still image standard, JPEG (Joint Photographic Experts Group), has contributed greatly to multimedia service by providing of a variety of applications and hardware since it was adopted as a still image compression standard. Because of its limited performance for use in the 21^{st} century, however, JPEG finds its current use in a narrow range of applications. The shortcomings of JPEG include low compression performance, unintegrated lossy/lossless compression systems, infeasibility for a large volume of image data, low transmission stability in a noise environment, low compression performance for artificial images such as graphic images, and degraded compression performance for hybrid text.

JPEG2000 emerged to solve the JPEG problems. JPEG2000 is the new still image standard, which integrates various functionalities in addition to JPEG, resulting from a collaborative work between the International Telecommunication Union (ITU: ITU-R SG8) and the International Organization for Standardization (ISO: ISO/IEC JCT1/SC29/WG1). JPEG2000 offers one common code for different image types having different characteristics, such as nature images, scientific images, medical images, remote sensed images, text images, and graphic images.

JPEG2000 can be widely used in any field associated with still images such as medical pictures, Internet/WWW images, remote sensing, image storing, graphic and computer synthesized images, facsimiles, printed and published images, laser printing, digital cameras, scanners and digital copiers, economic text, security cameras, digital library of pictures and art work, and camera phones.

The recent years have witnessed increasing demands for transmission of a huge amount of data at an ultra high speed under a low-rate, narrow-bandwidth environment like a computer network, a public telephone network, and a radio channel.

For independent encoding/decoding of an MPEG (Moving Picture Experts Group) or H.26x moving picture or a JPEG still image, DCT (Discrete Cosine Transform), DWT, ME (Motion Estimation), or MC (Motion Compensation) is used in which an image is decomposed into blocks of a predetermined size and is compressed/transformed on an image block basis. Transmission of data using such a data compression and transformation scheme results in low data rate and does not ensure a minimum acceptable level of image quality for users.

Mobile communication technology has evolved from the first generation analog communication systems to the third generation asynchronous WCDMA (IMT2000) communication systems via the second generation digital communication systems. Currently, the mobile communication technology has reached the developmental level at which wideband roaming service is available worldwide. The asynchronous WCDMA system enables retrieval of moving pictures/still images in VOD (Video On Demand), transmission/reception of images captured by a camera, and bi-directional communication between mobile subscribers through their terminals, as well as wireless multimedia service.

Aside from a part responsible for the MODEM function, a part responsible for multimedia function-including applications gains an increasing importance in a WCDMA terminal. Accordingly, the constraint of processing a variety of multimedia data including still images and moving pictures and a data computation requirements are increased for the CPU (Central Processing Unit) of the WCDMA terminal. Accordingly, in addition to a typical MODEM for providing basic functions for communication, there is a need for a module and memory for reducing the computation and errors of multimedia data applications in order to use the WCDMA communication scheme efficiently.

Traditionally, a DCT/IDCT algorithm and a DWT/IDWT algorithm were used to encode/decode MPEG-1, 2, 4 or H.26x moving pictures and JPEG or JPEG2000 still images. In the DCT/IDCT algorithm, each image frame of a moving picture is divided into 8×8-sized blocks and the blocks are separately encoded/decoded. The DWT/IDWT algorithm divides each image into tiles of an appropriate size and encodes/decodes each tile or each region including a plurality of tiles in compliance with the JPEG2000 still image standard.

As described above, in the JPEG2000 still image standard, the DWT/IDWT algorithm divides the still image into appropriate segments by tiling and encodes/decodes on a per-tile basis. When encoding/decoding each image tile, an image coefficient representing the image tile is encoded/decoded. When a coded image is recovered in this method, the recovered image has a high resolution, but the computation of the image coefficients of entire image tiles increases computation volume and image complexity. Also, a memory having a large enough storage capacity to store complex images and computation results is required to encode/decode images in this method. Because complex images are calculated, a great deal of time is consumed for DWT/IDWT processing. Consequently, the DWT/IDWT method is not feasible for real-time processing of images.

### SUMMARY OF THE INVENTION

Therefore, the present invention has been designed to substantially solve at least the above problems and/or disadvantages and to provide at least the advantages below. Accordingly, an object of the present invention is to provide a DWT/IDWT apparatus for reducing a time required for encoding/decoding a still image to enable real-time transmission according to JPEG2000, and a fast discrete wavelet encoding method using the DWT/IDWT apparatus.

Another object of the present invention is to provide a DWT/IDWT apparatus for increasing the speed of computation for DWT/IDWT in encoding/decoding a still image, such as a JPEG2000 still image, and ensuring a minimum acceptable still image quality level, and a fast discrete wavelet encoding method using the DWT/IDWT apparatus.

The above and other objects are achieved by providing a fast discrete wavelet encoding apparatus and method for encoding and decoding a still image are provided. According to one aspect of the present invention, in a fast discrete wavelet encoding apparatus, a sub-sampler sub-samples an input image to image blocks of a pixel size decreased from the pixel size of the input image at a predetermined ratio. An energy calculator calculates the energy of the input image block by block, each block having a predetermined number of pixels. An adaptive image decomposer adaptively determines a lifting transform level for each image block according to the energy of the block. A lifting encoder performs lifting encoding on the input image according to the lifting transform levels determined for the image blocks.

According to another aspect of the present invention, in a fast discrete wavelet encoding method in a fast discrete wavelet encoding apparatus for encoding and decoding a still image, the energy of an input image is calculated block by block. Each block has a predetermined number of pixels. A lifting transform level for each block is determined adaptively according to the energy of the block. Then, lifting encoding is performed on the input image according to the lifting transform levels determined for the blocks of the image.

### BRIEF DESCRIPTION OF THE DRAWINGS

The above and other objects, features, and advantages of the present invention will become more apparent from the following detailed description when taken in conjunction with the accompanying drawings in which:

FIG. 1 is a schematic block diagram of a conventional system for encoding and decoding a JPEG2000 still image;

FIG. 2 illustrates transformation of a source image in the DWT block illustrated in FIG. 1; FIG. 3 illustrates 3-level decomposition of an image block in the DWT

block illustrated in FIG. 1;

FIG. 4 is a block diagram of a DWT apparatus for fast discrete wavelet encoding of a still image according to a preferred embodiment of the present invention;

FIG. 5 illustrates a basic lazy wavelet transform (LWT) apparatus for performing LWT;

FIG. 6 schematically illustrates a lifting encoder for encoding a still image;

FIG. 7 illustrates the operation of each function block in the DWT apparatus illustrated in FIG. 4; and

FIG. 8 is a flowchart illustrating a fast discrete wavelet encoding method in the DWT apparatus according to an embodiment of the present invention.

### DETAILED DESCRIPTION OF THE PREFERRED EMBODIMENT

Preferred embodiments of the present invention will be described in detail herein below with reference to the accompanying drawings. In the following description, well-known functions or constructions are not described in detail since they would obscure the invention in unnecessary detail.

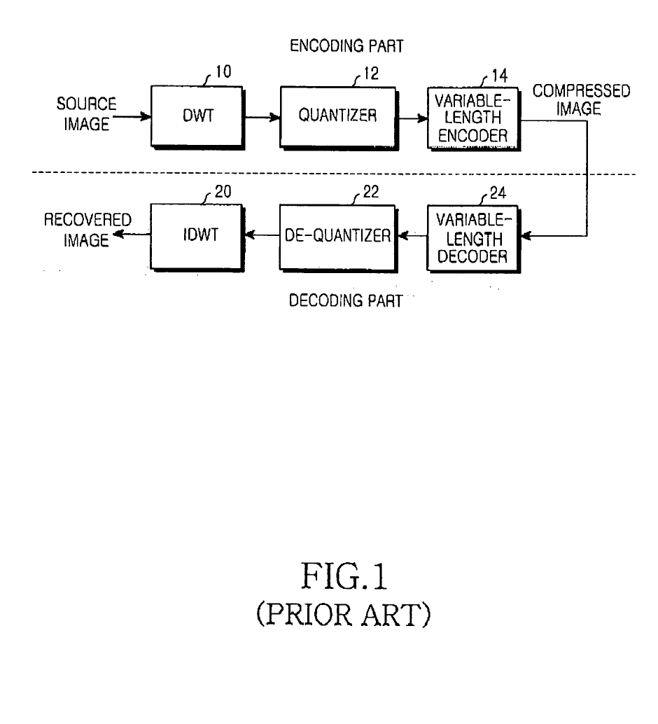

FIG. 1 is a schematic block diagram of a conventional system for encoding and decoding a JPEG2000 still image. As illustrated in FIG. 1, the still image encoding/decoding system is divided into an encoding part for compressing a still image and a decoding part for decompressing the compressed still image. The encoding part includes a DWT block 10, a quantizer 12, and a variable-length encoder 14.

The DWT block 10 discrete-wavelet-transforms an input source image signal. The quantizer 12 quantizes the discrete-wavelet-transformed image in units of blocks, each having a predetermined number of pixels, and scans the quantization values of the blocks in a zig-zag fashion. The variable-length encoder 14 converts the quantization values received from the quantizer 12 to variable-length coded data and outputs the variable-length coded data, i.e., a compressed image, to a sequential coded bit stream through a bit stream generator (not shown).

The decoding part includes a variable-length decoder 24, a dequantizer 22, and an IDWT block 20. The variable-length decoder 24 variable-length-decodes an input compressed image, thereby achieving the quantization value of each block having a predetermined number of pixels. The dequantizer 22 obtains a discrete-wavelet-transformed image by dequantizing the variable-length-decoded quantization values. The IDWT block 20 performs an IDWT operation on the discrete-wavelet-transformed image, thereby recovering an original image.

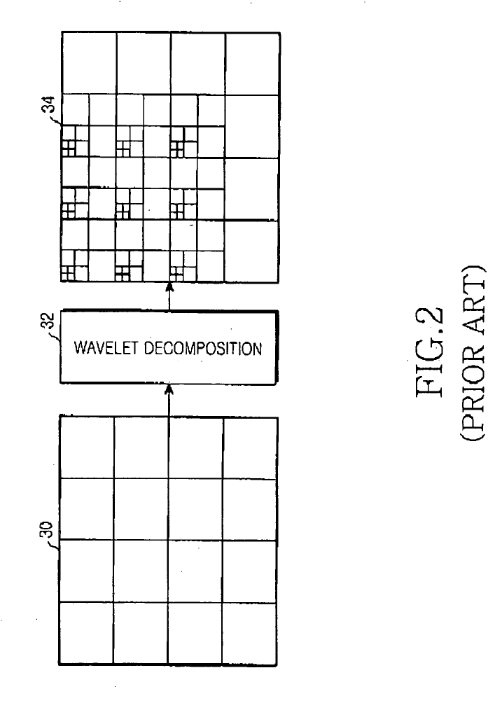

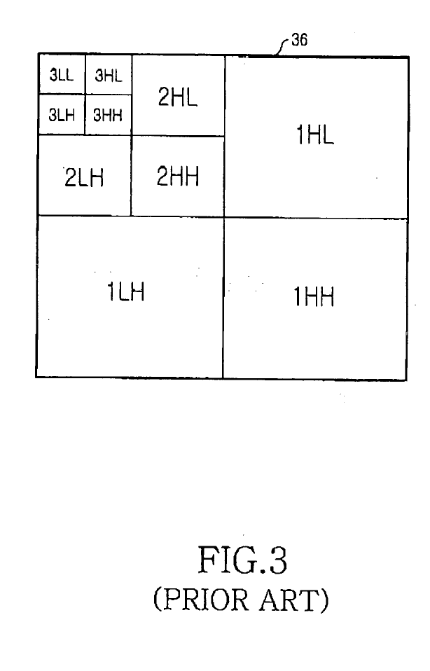

FIG. 2 illustrates a transformation of a source image signal in the DWT block 10 illustrated in FIG. 1. Referring to FIG. 2, the DWT block 10 first divides a source image into tiles, each having a predetermined number of pixels, as indicated by reference numeral 30. The DWT block 10 then decomposes each tiled image block into sub-images in four regions by wavelet decomposition of the tiled image block, as indicated by reference numeral 32. That is, the DWT block 10 divides each image block into a low-frequency (L) component and a high-frequency (H) component by filtering in an X direction and then further divides the two L and H components into sub-images in four regions by filtering in a Y direction.

Each of the four sub-images is divided into LL, LH, HL, and HH bands. The LL-band image is the low-frequency component having a half of the resolution of the image before decomposition, and has a high energy concentration and important information about the image. The LH-, HL-, and HH-band images are the high-frequency component containing horizontal, vertical, and diagonal edge components. They are low in energy concentration and contain detailed information about the contour of the image.

The DWT block 10 further decomposes the LL-band image showing a higher energy concentration into four sub-images. By repeating the image decomposition, the DWT block 10 decomposes the resulting LL-band image into four sub-images. This is called multi-resolution decomposition. The energy is concentrated on the lowest frequency band of the multi-resolution decomposed image and the multi-resolution decomposed image has different frequency characteristics. Reference numeral 34 denotes an image each image block that is decomposed three times. The three-time decomposition of an image block is referred to as 3-level decomposition.

FIG. 3 illustrates a 3-level decomposed image block produced by the DWT block 10. Referring to FIG. 3, the DWT block 10 decomposes an image block into 1LL-, 1LH-, 1HL-, and 1HH-band images by 1-level decomposition. The DWT block 10 further decomposes the 1LL-band image into 2LL-, 2LH-, 2HL-, and 2HH-band images (2-level decomposition). The DWT block 10 again decomposes the 2LL-band image into 3LL-, 3LH-, 3HL-, and 3HH-band images (3-level decomposition).

The decomposed images are compressed by the quantizer 12 and the variable-length encoder 14, and recovered by the variable-length decoder 24, the dequantizer 22, and the IDWT block 20. In the conventional JPEG still image compression method, an image is decomposed at a level determined irrespective of the significance and complexity of a source image and all decomposed images are encoded and compressed. Therefore, the volume of computation required for image compression is increased and circuits involved with the image compression are complex. The resulting decreased process speed makes it difficult to transmit these images in real time.

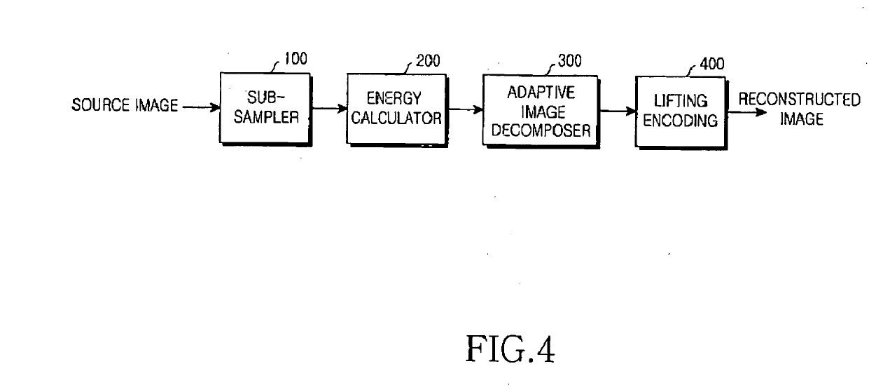

FIG. 4 is a block diagram of a DWT apparatus for performing a fast discrete wavelet encoding on a still image according to a preferred embodiment of the present invention. Referring to FIG. 4, the DWT apparatus comprises a sub-sampler 100, an energy calculator 200, an adaptive image decomposer 300, and a lifting encoder 400.

Upon input of a source image, the sub-sampler 100 sub-samples the source image to images having an eighth of its size. For example, if the source image has 256×256 pixels, it is sub-sampled to 32×32-pixel images by the sub-sampler 100. Hence, the source image is divided into 64 blocks. The present invention is applicable irrespective of whether sub-sampling is performed or not in the sub-sampler 100.

The energy calculator 200 calculates the energy of each image block having an eighth of the pixels of the source image by Eq. (1). In the embodiment of the present invention, the energy is calculated on a per-32×32 pixel block basis.

$${P}_{MB} = \frac{1}{{R}^{2}} {\sum }_{x = 0}^{R - 1} {\sum }_{y = 0}^{R - 1} S log S \\ S = \vert f ( x , y ) - E ( f ) \vert \qquad ( 1 )$$

where P_{MB} is the energy of an image block, f(x,y) is the value of a pixel of interest in the image block, E(f) is a mean pixel value of the image block, and R is the pixel size of the image block. In the embodiment of the present invention, R is 32.

The adaptive image decomposer 300 determines a lifting transform level at which an image is lifting-encoded according to the energy. As the energy increases, the adaptive image decomposer 300 increases the lifting transform level, and as the energy decreases, the adaptive image decomposer 300 decreases the lifting transform level. That is, the adaptive image decomposer 300 adaptively determines the lifting transform level according to the energy of each block, thereby achieving an image having an optimum image quality with respect to time required for wavelet transformation of the image.

The lifting encoder 400 compresses the source image by lifting encoding according to the lifting transform level for each block. The compressed source image is recovered by inverse lifting in a lifting decoder.

Accordingly, a still image can be encoded faster for real-time transmission by use of a lifting encoding scheme for fast discrete wavelet transform rather than a typical wavelet transform algorithm used for encoding a JPEG2000 still image.

Additionally, because a lifting transform level for lifting encoding is adaptively determined according to the energy of each block of a still image, and lifting encoding is performed at the lifting transform level, for fast discrete wavelet transform, the entire still image encoding is accelerated.

Table 1 below lists and compares time required for still image encoding in the conventional method and in the present invention.

TABLE 1

| | Wavelet transform by | Conventional wavelet |
|---|---|---|
| | lifting encoding | transform |
| Time required for still | 0.14[sec] | 0.22[sec] |
| image encoding | | |

As noted from Table 1, the encoding of a still image by the lifting scheme for fast discrete wavelet transform according to the present invention leads to a process speed increase of 60%, compared to the still image encoding by the conventional wavelet transform technique. Furthermore, the fast discrete wavelet transform by the lifting scheme has a smaller memory capacity requirement and a shorter encoding time, suitably for application to portable terminals.

Herein below, the lifting encoding scheme for fast discrete wavelet transform according to the present invention will be described.

A lifting scheme is derived from a wavelet filter bank design. The wavelet filter bank separates input data into a high-frequency component and a low-frequency component through filtering and downsampling.

A lazy wavelet transform (LWT) is a temporal application of the wavelet filter bank concept. In the LWT, input data is divided into even data and odd data according to time.

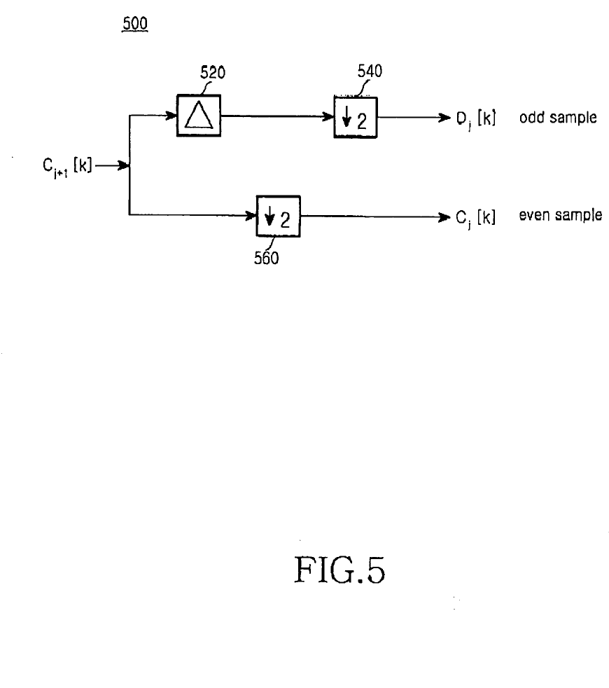

FIG. 5 illustrates an LWT apparatus for performing LWT. Referring to FIG. 5, a delay 520 delays input data by one sample. A first downsampler 540 downsamples the delayed data. As a result, the LWT apparatus obtains odd samples for the input data.

Additionally, a second downsampler 560 downsamples the input data, which is not delayed. As a result, the LWT apparatus obtains even samples for the input data.

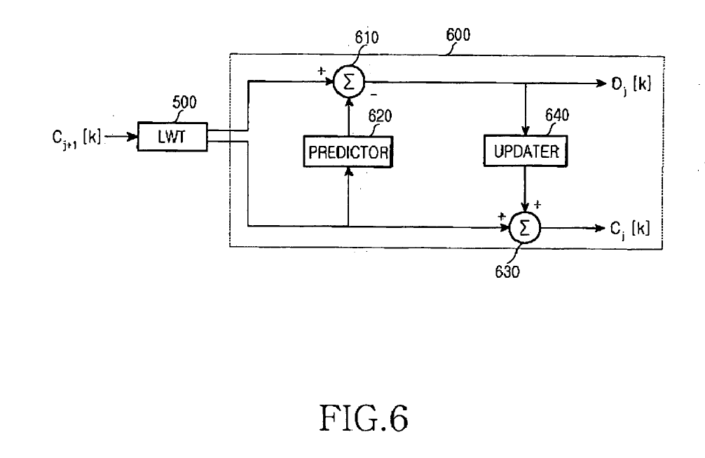

Because the LWT apparatus illustrated in FIG. 5 is not provided with functionalities required for transformation in existing still image compression techniques, such as de-correlation, frequency localization, and energy compaction, it cannot be used alone in transformation for still image compression. Accordingly, the lifting encoder adopting a lifting scheme illustrated in FIG. 6 is used for use in transformation for still image compression.

As indicated above, FIG. 6 schematically illustrates a lifting encoder for encoding a still image. Referring to FIG. 6, the lifting encoder comprises an LWT block 500 and a lifter 600, which includes a predictor 620 and an updater 640. The lifter 600 eliminates any redundancy of data output from the LWT block 500 to enhance de-correlation and energy compaction.

The predictor 620 predicts odd data Dⱼ[k] using even data Cⱼ[k] output from the LWT block 500. A subtractor 610 calculates the difference between the predicted odd data and the odd data from the LWT block 500. Here, the predictor 620 converts an odd coefficient dj to a high-frequency coefficient dj.

The updater 640 outputs an odd coefficient received from the subtractor 610 to an adder 630. The adder 630 adds the odd coefficient from the updater 640 to an even coefficient cj[k] of the even data from the LWT block 500, thereby producing a low-frequency coefficient cj[k].

A simple lifting encoder having a predictor and an updater is implemented for linear interpolation. A more complex lifting encoder is implemented for non-linear second-order interpolation. The linear interpolation using lifting encoding predicts a value between a first data value and a second data value using the first and second data values and connects the values by lines.

The lifting encoding scheme is faster in process speed than the typical wavelet encoding scheme. In more detail, the lifting encoding scheme requires a 3 floating points operation per sampling, whereas the typical wavelet encoding scheme requires 6 floating points operation per sampling. This is because the lifting encoding scheme does not need a memory for temporarily storing still images to be encoded.

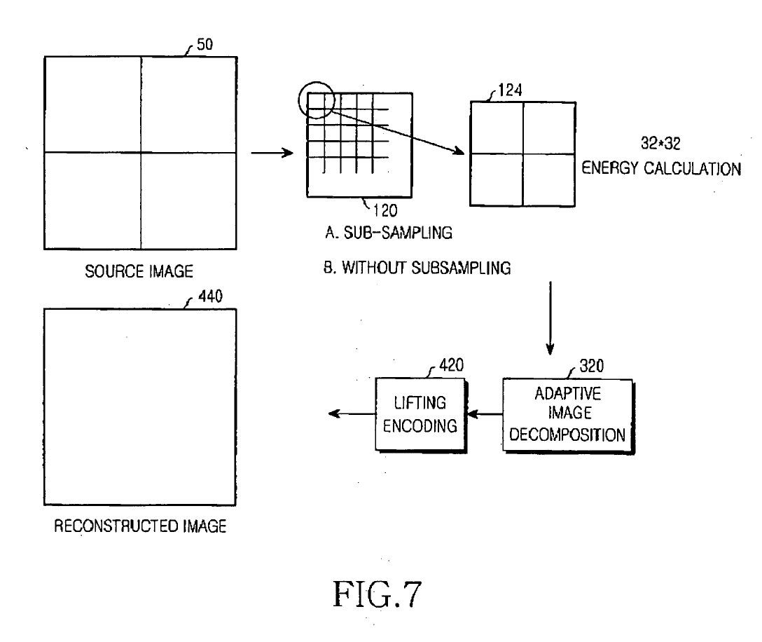

FIG. 7 illustrates the operation of each function block in the DWT apparatus for fast discrete wavelet transform illustrated in FIG. 4. Referring to FIG. 7, upon receiving a source image 50, the sub-sampler 100 sub-samples the source image 50 to produce images 120 having an eighth of the number of pixels of the source image 50. Alternatively, the sub-sampler 100 may not sub-sample the source image 50.

The energy calculator 200 calculates the energy of the sub-sampled images or the source image 50 block by block. Each block has 32×32 pixels, herein. The adaptive image decomposer 300 determines a lifting transform level for lifting encoding of each image block according to its energy. If the energy increases, the adaptive image decomposer 300 increases the lifting transform level. However, if the energy decreases, the adaptive image decomposer 300 decreases the lifting transform level, as indicated by reference numeral 320. Therefore, an image having an optimum quality with respect to time required for wavelet transformation of the image is achieved.

The lifting encoder 400 compresses each image block according to the lifting transform level determined for the image block, as indicated by reference numeral 420. The fast discrete wavelet encoding by lifting encoding the image blocks according to lifting transform levels adaptively determined according to the energy values of the image blocks results in a reconstructed image 440.

Accordingly, it can be concluded that a still image can be encoded faster for real-time transmission by using the lifting encoding scheme for fast discrete wavelet transform, rather than using the typical wavelet transform algorithm for encoding a JPEG2000 still image.

Additionally, because a lifting transform level for lifting encoding is adaptively determined according to the energy of each block of a still image and lifting encoding is performed at the lifting transform level, for fast discrete wavelet transform, the entire still image encoding is accelerated.

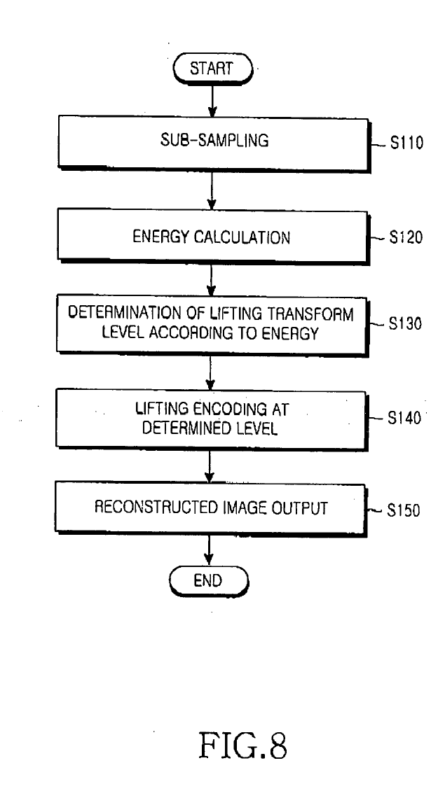

FIG. 8 is a flowchart illustrating a fast discrete wavelet encoding method in the DWT apparatus illustrated in FIG. 4 according to an embodiment of the present invention. Referring to FIG. 8, upon input of a source image, the sub-sampler 100 sub-samples the source image to images having an eighth of its size in step S110. In step S120, the energy calculator 200 calculates the energy of each image block having an eighth of the pixels of the source image using Eq. (1).

The adaptive image decomposer 300 determines a lifting transform level for each image block according to the energy of the image block in step S130. It is preferable that if the energy is higher than a predetermined threshold, the adaptive image decomposer 300 selects a higher lifting transform level than a predetermined reference level, and if the energy is lower than the threshold, the adaptive image decomposer 300 selects a lower lifting transform level than the reference level. The reference level is the mean of the maximum and minimum of the energies of the coefficients of all image blocks.

The lifting encoder 400 lifting encodes the image blocks according to the lifting transform level for each block in step S140. The lifting encoding is performed in the lift encoder configured for 1-level lifting encoding illustrated in FIG. 6. Therefore, as the lifting transform level is increased by 1, the lift encoder 400 has an additional lift encoder, as illustrated in FIG. 6, connected to the output Cⱼ[k]. As a result, if the lift transform level is 3, an input image is lifting encoded in a lift encoder comprising three lift encoders as illustrated in FIG. 6. The lifting encoder 400 outputs the resulting reconstructed image in step S150.

Accordingly, a still image can be encoded faster for real-time transmission by using a lifting encoding scheme for fast discrete wavelet transform rather than a typical wavelet transform algorithm used for encoding a JPEG2000 still image.

Additionally, because a lifting transform level for lifting encoding is adaptively determined according to the energy of each block of a still image and lifting encoding is performed at the lifting transform level, for fast discrete wavelet transform, the entire still image encoding is accelerated.

While the present invention has been shown and described with reference to certain preferred embodiments thereof, it will be understood by those skilled in the art that various changes in form and details may be made therein without departing from the spirit and scope of the present invention as defmed by the appended claims.

1. A fast discrete wavelet encoding apparatus for encoding and decoding a still image, comprising:
an energy calculator for calculating an energy of an input image, block by block, each block having a predetermined number of pixels;
an adaptive image decomposer for adaptively determining a lifting transform level for each block according to the energy of the block; and
a lifting encoder for lifting encoding the input image according to the lifting transform levels determined for each block of the image.

2. The fast discrete wavelet encoding apparatus of claim 2, wherein the energy calculator calculates the energy of each block by
$${P}_{MB} = \frac{1}{{R}^{2}} {\sum }_{x = 0}^{R - 1} {\sum }_{y = 0}^{R - 1} S log S$$
$$S = \vert f ( x , y ) - E ( f ) \vert$$
where P_{MB} is an energy of an image block, f(x,y) is a value of a pixel in an image block, E(f) is a mean pixel value of an image block, and R is a pixel size of an image block.

3. The fast discrete wavelet encoding apparatus of claim 1, further comprising a sub-sampler for sub-sampling the input image at a predetermined ratio to an image block of a pixel size decreased from an original pixel size of the input image.

4. The fast discrete wavelet encoding apparatus of claim 3, wherein the predetermined ratio for sub-sampling is ⅛.

5. The fast discrete wavelet encoding apparatus of claim 4, wherein the energy calculator calculates an energy of sub-sampled images of an eighth of the pixel size of the input image, block by block, each block having 32×32 pixels.

6. The fast discrete wavelet encoding apparatus of claim 1, wherein the adaptive image decomposer increases the lifting transform level of an image block if an energy of the image block is greater than a predetermined threshold, and decreases the lifting transform level if the energy is less than the predetermined threshold.

7. A fast discrete wavelet encoding method in a fast discrete wavelet encoding apparatus for encoding and decoding a still image, comprising the steps of:
calculating an energy of an input image, block by block, each block having a predetermined number of pixels;
adaptively determining a lifting transform level for each block according to the energy of each block; and
lifting encoding the input image according to the lifting transform levels determined for each block of the image.

8. The fast discrete wavelet encoding method of claim 7, wherein the step of calculating the energy of the input image comprises the step of calculating the energy of each block by
$${P}_{MB} = \frac{1}{{R}^{2}} {\sum }_{x = 0}^{R - 1} {\sum }_{y = 0}^{R - 1} S log S$$
$$S = \vert f ( x , y ) - E ( f ) \vert$$
where P_{MB} is an energy of an image block, f(x,y) is a value of a pixel in an image block, E(f) is a mean pixel value of an image block, and R is a pixel size of an image block.

9. The fast discrete wavelet encoding method of claim 7, further comprising the step of sub-sampling the input image at a predetermined ratio to an image block of a pixel size decreased from an original pixel size of the input image, before calculating the energy of the input image.

10. The fast discrete wavelet encoding method of claim 9, wherein the predetermined ratio for sub-sampling is ⅛.

11. The fast discrete wavelet encoding method of claim 10, wherein the step of calculating the energy of the input image comprises the step of calculating the energy of sub-sampled images of an eighth of the original pixel size of the input image, block by block, each block having 32×32 pixels.

12. The fast discrete wavelet encoding method of claim 7, wherein the step of adaptively determining the lifting transform level for each block comprises the step of increasing the lifting transform level of an image block if the energy of the image block is greater than a predetermined threshold, and decreasing the lifting transform level if the energy is less than the predetermined threshold.
